(19) United States
(12) Patent Application Publication
(10) Pub. No.: US 2025/0082443 A1
(43) Pub. Date: Mar. 13, 2025

(54) DENTAL IMPLANT STRUCTURE

(71) Applicant: INNODEN Co., Ltd., Siheung-si, Gyeonggi-do (KR)

(72) Inventor: Cheon Seok JANG, Ansan-si, Gyeonggi-do (KR)

(73) Assignee: INNODEN Co., Ltd., Siheung-si, Gyeonggi-do (KR)

(21) Appl. No.: 18/280,664

(22) PCT Filed: Jun. 30, 2023
(86) PCT No.: PCT/KR2023/009198

§ 371 Date: Sep. 6, 2023

(30) Foreign Application Priority Data
Oct. 11, 2022 (KR) 10-2022-0129440

(51) Int. Cl. A61C 8/00

(52) U.S. Cl. CPC A61C 8/0057; A61C 8/0012; A61C 8/0074; A61C 2201/007

(57) ABSTRACT

The present invention relates to a dental implant structure including an abutment and a crown (artificial tooth), and more particularly, according to the present invention, a crown is not fixed to an abutment through an adhesive, but is coupled and fixed to the abutment with a locking part having various structures, so it is possible to easily detaching the crown, and an elastomer is formed on an outer surface of a post of the abutment or an inner surface of the crown to block a direct contact of the crown with the abutment, so it is possible to buffer and relieve occlusal force repeatedly applied to the crown using elastic force to prevent the crown, the abutment, and/or the fixture, or the like from being fractured due to the repetitive occlusal force, and prevent foreign substances from entering between the crown and the abutment.

### TECHNICAL FIELD

The present invention relates to a dental implant structure including an abutment and a crown (artificial tooth), and more particularly, to a dental implant structure capable of easily detach a crown coupled to the abutment, relieving a pressure or shock transmitted to the abutment or a fixture, which is a lower structure, due to a repetitive occlusal force applied to the crown, and preventing foreign substances from entering a gap between the crown and the abutment without using an adhesive anywhere between the abutment and the crown.

### BACKGROUND ART

An implant is basically a fixture that is implanted in an alveolar bone, an abutment that is fixed to the fixture and supports lateral or horizontal pressure in response to occlusal force applied during mastication, and a crown (artificial tooth) that restores an aesthetic beauty similar to a natural tooth by covering an upper portion of the abutment.

However, the conventional dental implant structure may cause the following problems.

First, a problem may occur due to the use of an adhesive or a fixing member such as a screw or cap to couple the crown to the abutment. For example, in the case of using the adhesive, side effects such as inducing inflammation around gums and implants occur due to the remaining adhesive that is not removed. In the case of using the fixing member such as the screw or cap, the pore result should be more precise than when using the adhesive.

Second, since there is no component capable of absorbing occlusal force, such as a periodontal ligament of natural teeth, a problem may occur in that the abutment or the fixture, which is a lower structure, is fractured. The crown is manufactured in an optimized shape and size corresponding to the shape and size of the abutment by using a hard material to mash food well during mastication. For example, since the crown is manufactured by casting dental metal or dental gold or by machining a zirconium oxide block through a CAD/CAM operation, when the occlusal force is repeatedly applied to the crown, the fixture or the abutment and/or the abutment screw, etc., which are the lower structures of the crown, is repeatedly applied with the strong occlusal force, so a problem may occur in that the fixture or the abutment and/or the abutment screw, or the like may be fractured.

Third, a problem may occur in that when the crown is coupled to the abutment without using the adhesive, fine gaps may occur between the crown and the abutment while the crown is coupled to the abutment due to technical limitations, and foreign substances such as food flow in between the crown and the abutment due to these fine gaps to cause inflammation around the abutment, cause bad breath, and corrode the abutment and fixture.

### RELATED ART DOCUMENTS

### Patent Documents

(Patent Document 1) KR 10-2009-0110136 A, 2009. 10. 21.

(Patent Document 2) KR 10-2323728 B1, 2021. 11. 03.

### DISCLOSURE

### Technical Problem

Therefore, an object of the present invention provides a dental implant structure capable of easily detach a crown coupled to the abutment, relieving a pressure and shock applied by a repetitive occlusal force to prevent an abutment, a fixture, etc., which are lower structures of the crown, from being fractured, and preventing foreign substances from entering a gap between the crown and the abutment without using an adhesive at all when the crown is coupled to the abutment to prevent inflammation from occurring around the abutment, and prevent the abutment, the fixture, and the like from corroding.

In addition, the present invention is not limited to the above-described purpose, and various objects may be additionally provided through technologies described through embodiments and claims to be described later.

### Technical Solution

According to an aspect of the present disclosure, a dental implant structure includes: an abutment; a crown covering a post of the abutment and coupled and fixed to the post through a locking part; and an elastomer positioned between the post and the crown.

The locking part may be formed of an elastic ring inserted into an elastic ring insertion groove formed in a band shape on the outer surface of the post, and the elastic ring may be caught in a locking groove formed on an inner surface of an accommodating space of the crown into which the post is inserted.

The locking part may be formed of a locking protrusion whose diameter is expanded at an upper end portion of the post, and the locking protrusion may be caught in a locking groove formed on an inner surface of the accommodating space of the crown into which the post is inserted.

The locking part may be formed of a fixing member including a male screw part screwed to a coupling groove part formed in the post, and a head part formed at an upper end of the male screw part and caught in an inner surface of the accommodating space of the crown into which the post is inserted.

The elastomer may be attached to the outer surface of the post or the inner surface of the crown, or may be independently manufactured and installed between the post and the crown.

The elastomer may be made of any one selected from a silicone rubber material containing silicon, a synthetic rubber material containing fluorine, or a metal material made of a Ni—Ti alloy.

The elastomer may be formed in a form of a fabric or membrane using a Ni—Ti alloy wire.

An empty space of the membrane formed through the Ni—Ti alloy wire may be filled with a silicone rubber material containing silicon or a synthetic rubber material containing fluorine.

An antibiotic, an antibacterial agent, or a fragrance may be added to the elastomer.

The elastic ring may be formed in a form of an O-ring or a C-ring.

### Advantageous Effects

As described above, according to the dental implant structure of the present invention, a crown is not fixed to an abutment through an adhesive, but is coupled and fixed to the abutment with a locking part (elastic ring, locking protrusion, fixing member), so it is possible to easily detach the crown.

In addition, according to a dental implant structure of the present invention, by forming an elastomer on an outer surface of a post of an abutment or an inner surface of a crown to block a direct contact of the crown with the abutment, it is possible to buffer and relieve occlusal force repeatedly applied to the crown using elastic force to prevent the crown, the abutment, and/or the fixture, etc., from being fractured due to the repetitive occlusal force, and prevent foreign substances from entering between the crown and the abutment.

In addition, according to a dental implant structure of the present invention, since there is no need to use an adhesive at all when positioning a crown on a post portion of an abutment, it is possible to prevent inflammation around an implant due to a residual adhesive and freely detach the crown.

### DESCRIPTION OF DRAWINGS

FIG. 1 is a diagram illustrating a dental implant structure according to a fifth embodiment of the present invention.

FIG. 2 is a cross-sectional view of the abutment illustrated in FIG. 1.

FIG. 3 is a cross-sectional view of the crown illustrated in FIG. 1.

FIG. 4 is a cross-sectional view illustrating a process of coupling the crown illustrated in FIG. 3 to the abutment.

FIG. 5 is a cross-sectional view of an abutment in which an elastomer is formed on an outer surface as another example of the present invention.

FIG. 6 is a cross-sectional view illustrating a process of coupling the crown illustrated in FIG. 5 to the abutment.

FIG. 7 is a diagram illustrating a dental implant structure according to a second embodiment of the present invention.

FIG. 8 is a cross-sectional view of the crown illustrated in FIG. 7.

FIG. 9 is a cross-sectional view illustrating a process of coupling the crown illustrated in FIG. 7 to the abutment.

FIG. 10 is a diagram illustrating a dental implant structure according to a third embodiment of the present invention.

FIG. 11 is a cross-sectional view of the crown illustrated in FIG. 10.

FIG. 12 is a cross-sectional view illustrating a state in which the crown illustrated in FIG. 11 is coupled to the abutment through a fixing member.

### MODE FOR INVENTION

Various advantages and features of the present invention and methods accomplishing them will become apparent from the following description of embodiments with reference to the accompanying drawings. Also, like reference numerals designate like elements throughout this specification. In addition, each component illustrated in each figure may be excessively illustrated in size and shape, which is for convenience of description and is not intended to be limited. In addition, when described as “A and/or B,” it may mean both A and B, or either A or B.

The technical features of the dental implant structure according to the present invention are largely: \textcircled{1} a crown coupled to an abutment is coupled and fixed to the abutment through a locking part without using an adhesive. \textcircled{2} An elastomer is positioned between the abutment and the crown to cushion therebetween.

The locking part may be any one of an elastic ring (first embodiment), a locking protrusion (second embodiment) whose diameter is expanded to an upper end portion of the post, or a fixing member (third embodiment including a male screw part and a head part.

The elastomer may be formed on an outer side surface of the abutment or an inner side surface of the crown.

Such an elastomer is formed, for example, by a method (application method) of applying a liquefied elastomer material to an outer surface of the abutment or an inner surface of an accommodating space of the crown and then curing the liquid elastomer material, or by a method of spraying a gaseous elastomer material to the outer surface of the abutment or the inner surface of the accommodating space of the crown and then curing the gaseous elastomer material. Alternatively, it may be formed by a method of independently manufacturing an elastomer and then installing the manufactured elastomer between an abutment and a crown.

Hereinafter, preferred examples for implementing the technical features of the dental implant structure according to the present invention will be described in detail with reference to the accompanying drawings.

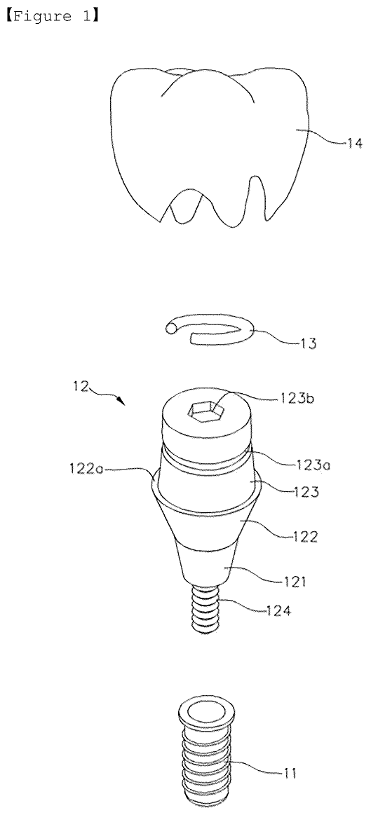

FIG. 1 is a diagram schematically illustrated to describe a dental implant structure according to a first embodiment of the present invention, and is a diagram separately illustrating each component of the implant structure.

Referring to FIG. 1, the dental implant structure according to the first embodiment of the present invention includes an elastic ring 13 for coupling between a crown 14 and an abutment 12. The elastic ring 13 provides a soft coupling characteristic when coupling the crown 14 to the abutment 12, whereas the crown 14 performs a catching (locking) function so that it is not easily separated after being coupled to the abutment 12.

The abutment 12 may include, for example, a fixing part 121, a cuff 122 integrally formed at the upper portion of the fixing part 121, and a post 123 integrally formed at the upper portion of the cuff 122. In this case, the fixing part 121, the cuff 122, and the post 123 may be formed of one body.

In order to fix the abutment 12 to the fixture 11, a screw 124 may be integrally formed (in one-piece structure) at a lower portion of the fixing part 121. In addition, the screw may be formed of a two-piece structure in which it is individually separated from the abutment 12. In the case of the two-piece structure, the screw may be inserted through a hollow of the abutment 12.

The cuff 122 may have a funnel structure with a width extending from the fixing part 121 toward the upper portion. In addition, in order to generate a step at an interface where the post 123 and the cuff 122 meet, the post 123 may be formed to have a diameter (width) smaller than that of an upper surface 122a of the cuff 122, and may be formed of a structure in which the width is the same or decreases toward the upper portion.

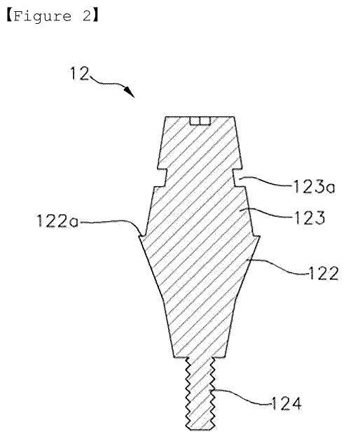

FIG. 2 is a schematic cross-sectional view of the abutment illustrated in FIG. 1.

Referring to FIGS. 1 and 2, the post 123 is provided with an elastic ring insertion groove 123a formed in a ring shape along the circumference. The elastic ring 13 illustrated in FIG. 1 is coupled to the inside of the elastic ring insertion groove 123a. In this case, one or two or more elastic ring insertion grooves 123a may be provided in the post 123.

A depth of the elastic ring insertion groove 123a is formed to correspond to a thickness of the elastic ring 13. When the crown 14 is covered on the post 123 of the abutment 12, the elastic ring 13 is contracted by an inner wall of the crown 14 and enters the elastic ring insertion groove 123a in a depth direction. In this case, the elastic ring insertion groove 123a is formed at a depth that does not interfere with the entry of the crown 14. The depth of the elastic ring insertion groove 123a may vary depending on the material of the elastic ring 13. For example, when the elastic ring 13 is made of a synthetic resin material (plastic material) or a metal material, the elastic ring 13 may be formed larger than the thickness of the elastic ring 13. For example, the depth of the elastic ring insertion groove 123a may be formed to be 0.1 mm to 0.5 mm deeper than the thickness of the elastic ring 13. The ring is formed in a C shape. As another example, when the elastic ring 13 is made of a material having its own elasticity that may change in volume, the elastic ring 13 may be formed in an O-ring shape that does not fall off. In this case, the depth of the elastic ring insertion groove 123a may be formed to be 0.1 mm to 0.5 mm shallower than the thickness of the O-ring.

The diameter of the elastic ring 13 may be smaller than the diameter of the post 123 at a horizontal level of the post 123 to which the elastic ring 13 is coupled, and may be the same as or slightly smaller than the diameter of the ring-shaped elastic ring insertion groove 123a. Accordingly, in order to couple the elastic ring 13 to the elastic ring insertion groove 123a, the diameter of the elastic ring 13 should be expanded to be coupled to the elastic ring insertion groove 123a, and after coupled to the elastic ring insertion groove 123a, the diameter of the elastic ring 13 is reduced by its own elasticity.

The elastic ring 13 may be an elastomer having elasticity. For example, when the elastic ring 13 is manufactured using a metal material or a synthetic resin material whose volume does not change, the effect is obtained through a change in length due to elasticity, and when the elastic ring 13 is made of a silicone material that is an elastomer whose volume changes, a synthetic rubber material such as fluororubber, a metal material (for example, woven fabrics or membrane of thin nitinol wire (Nitai wire) made of an Ni—Ti alloy) in the form of a fabric having elasticity, or a synthetic resin material having elasticity, the elastic ring may be formed in an O-ring shape.

As illustrated in FIG. 1, for example, when the abutment 12 has a one-piece structure, an upper surface of the post 123 may be provided with a driver groove 123b to couple the abutment 12 to the fixture 11. For example, the driver groove 123b may be formed in a hexa (hexagonal) shape. As another example, when the abutment 12 has a two-piece structure, a hollow penetrating up and down may be formed inside the abutment 12 so that a screw is inserted.

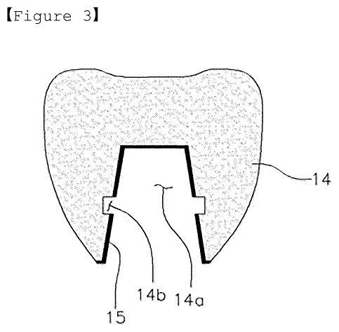

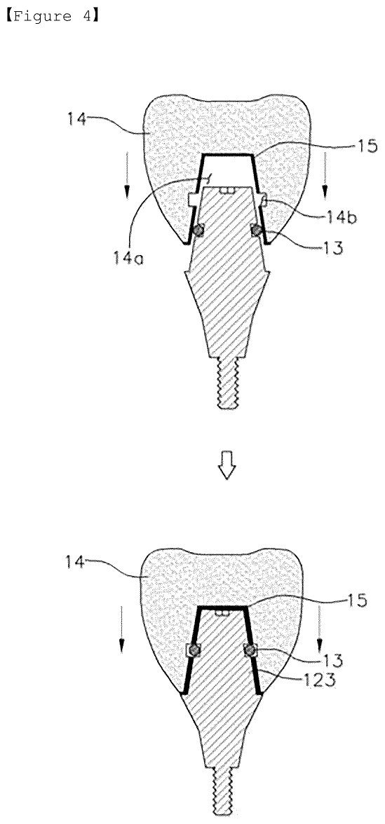

FIG. 3 is a cross-sectional view schematically illustrating the crown illustrated in FIG. 1, and FIG. 4 is a cross-sectional view schematically illustrating a process of coupling the crown illustrated in FIG. 3 to the abutment.

Referring to FIGS. 3 and 4, the crown 14 has an accommodating space 14a in which the post 123 is accommodated, and a locking groove 14b is formed in the accommodating space 14a into which the elastic ring 13 is inserted and caught.

The locking groove 14b may be cut out along the inner circumference of the accommodating space 14a to correspond to the elastic ring insertion groove 123a while the crown 14 is completely coupled to the post 123 so that the elastic ring may be caught.

An inner surface of the accommodating space 14a may have a shape corresponding to an outer surface of the post 123. Accordingly, as illustrated in FIG. 4, the post 123 may be tightly coupled to the accommodating space 14a of the crown 14 while the post 123 is inserted into the accommodating space 14a of the crown 14.

As illustrated in FIG. 3, the elastomer 15 may be formed on an inner surface of the crown 14, that is, on the inner surface of the accommodating space 14a. The elastomer 15 serves to block a direct contact between the crown 14 and the post 123. When the elastomer 15 does not exist between the crown 14 and the post 123, there is the direct contact between the crown 13 and the post 123, which prevents the elastic ring 13 from contracting. That is, when the crown 14 and the post 123 are in a direct contact with each other, since there is no extra space between the crown 14 and the post 123 for the elastic ring 13 to contract, the buffering action using the elastic force of the elastic ring 13 does not work smoothly.

The elastomer 15 may be formed between the crown 14 and the post 123 and buffer when the occlusal force is repeatedly applied to prevent fracture due to the collision between the crown 14 and the abutment 12. In addition, as the crown 14 is contracted to a certain thickness when coupled to the post 123, it tightly fills the gap between the crown 14 and the post 123. In this way, it is possible to fundamentally block the inflow of foreign substances into the gap between the crown 14 and the post 123.

The elastomer 15 may be made of a silicone or rubber material having elasticity. In addition, all materials having elasticity, including the material used as the elastic ring 13, may be used. In addition, the elastomer 15 may be formed through a coating process to be uniformly formed on the inner surface of the crown 14, for example. After uniformly spraying and applying a coating solution to the inner surface of the crown 14, the applied coating solution may be cured and uniformly formed to a certain thickness.

As the coating solution, a material that has elasticity and may be coated on the inner surface of the crown 14 by a spraying method using a sprayer or a spray nozzle may be used. For example, any one selected from the group consisting of a liquefied synthetic resin material, a liquefied synthetic rubber material, a liquefied silicone material, and a liquefied silicone rubber material may be used.

For example, the elastomer 15 may be formed by spraying and coating a coating solution on the inner surface of the accommodating space 14a of the crown 14 using a spray nozzle and then curing the coating solution. In this case, the elastomer 15 may be formed to a thickness of 20 μm to 300 μm in consideration of the fact that the movement of natural teeth by the occlusal force is 30 μm on average.

In addition, the elastomer 15 may be formed to have elastic force greater than that of the elastic ring 13. The elastic ring 13 may be made of a material that is slightly harder than the elastomer 15 so as not to be easily separated from the abutment 12 while the crown 14 is coupled to the abutment 12.

In addition, the elastomer 15 may be made of a silicone material that is an elastomer whose volume changes, a synthetic rubber material such as fluororubber, a metal material (for example, woven fabrics or membrane of thin nitinol wire (Nitai wire) made of an Ni—Ti alloy) in the form of a fabric having elasticity, or a synthetic resin material having elasticity. In addition, when the elastomer 15 has a membrane structure made of an alloy metal, the empty space of the membrane may have a structure in which it is filled with a synthetic rubber material or a silicone rubber material. In addition, when the elastomer 15 is made of a synthetic rubber material such as fluororubber, a silicone rubber material using silicon as a main raw material, or a synthetic resin material, at least one of antibiotics, antibacterial agents, and aromatics may be further added.

As illustrated in FIG. 4, when the crown 14 is lowered while the elastic ring 13 is coupled to the elastic ring insertion groove 123a of the post 123 and the post 123 enters the accommodating space 14a, the inner wall (the inner wall of the accommodating space 14a) of the crown 14 presses the elastic ring 13. The elastic ring 13 is pressed and contracted by the inner wall of the crown 14 entering the post 123, and when the elastic ring 13 is partially inserted into the locking groove 14b of the crown 14, the pressing force applied to the elastic ring 13 from the crown 14 is removed, and the elastic ring 13 is restored to its original state by the elastic restoring force and is expanded.

When the crown 14 is completely coupled to the post 123 to cover the outer surface of the post 123, the elastic ring 13 is inserted and coupled between the locking groove 14b formed on the crown 14 and the elastic ring insertion groove 123a formed on the post 123. Therefore, the crown 14 is caught by the elastic ring 13 in a direction in which it is separated from the post 123 and thus is not easily separated from the post 123.

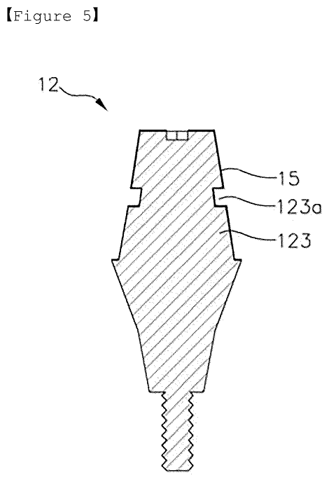

The elastomer 15 is formed on the inner surface of the crown 14 as illustrated in FIG. 3, which is an example. As illustrated in FIG. 5, the elastomer may be formed on the outer surface of the post 123 of the abutment 12 in contact with the inner surface of the crown 14. In addition, the elastomer 15 is a separate member manufactured independently and may be installed while it is simply inserted between the post 123 of the abutment 12 and the crown 14.

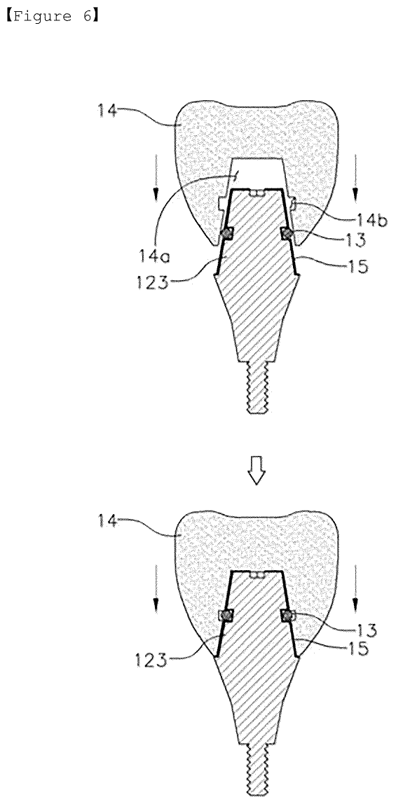

FIG. 5 a is cross-sectional view schematically illustrating an abutment having an elastomer formed on the outer surface as another example of the present invention, and FIG. 6 is a cross-sectional view schematically illustrating a process of coupling the crown illustrated in FIG. 5 to the abutment.

As illustrated in FIGS. 5 and 6, the elastomer 15 is formed on the outer surface of the post 123 of the abutment 12. In this case, the elastomer 15 may also be formed on a side surface of the post 123 facing the crown 14 and an upper surface except for the driver hole 123b, including an inner surface of the elastic ring insertion groove 123a. The elastomer 15 may show the same material and the same action effect as the structure formed on the inner surface of the crown 14, except that the elastomer illustrated in FIG. 3 is formed in a different position.

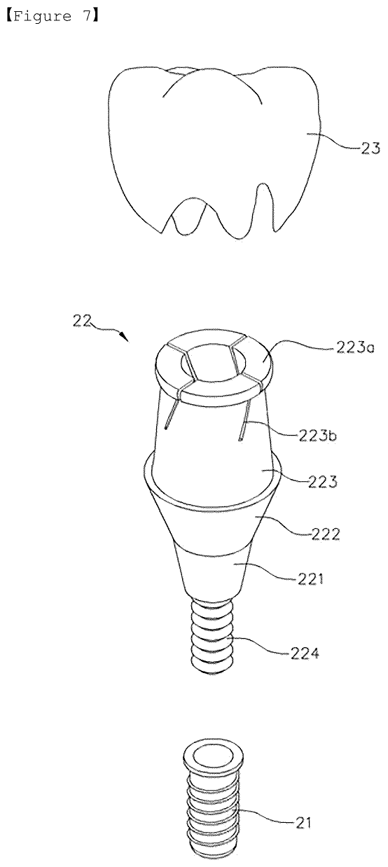

FIG. 7 is a diagram schematically illustrated to describe a dental implant structure according to a second embodiment of the present invention, and is a view separately illustrating each component of the implant structure.

Referring to FIG. 7, in the dental implant structure according to the second embodiment of the present invention, the fixture 21 and the crown 23 except for the abutment 22 may be formed in the same manner as in the first embodiment.

The abutment 22 includes, for example, a fixing part 221, a cuff 222, a post 223, and a screw 224. They are formed in an integral structure and may be formed through machining.

In the second embodiment of the present invention, the post 223 has a different structure from the post 123 illustrated in the first embodiment. As illustrated in FIG. 2, in the post 123 according to the first embodiment of the present invention, the crown 14 is formed in a structure in which it is coupled to the post 123 via the elastic ring 13 without an adhesive, whereas in the post 223 according to the second embodiment, the crown is formed in a structure in which it is coupled to a locking groove 23b formed on an inner surface of the crown 23 via a locking protrusion 223a formed at the upper end portion.

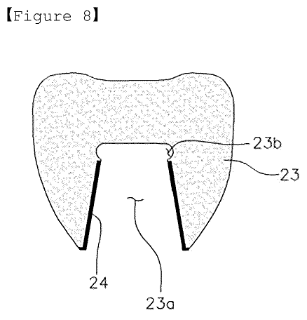

FIG. 8 is a schematic cross-sectional view for describing the crown illustrated in FIG. 7.

As illustrated in FIGS. 7 and 8, in the crown 23 according to the second embodiment of the present invention, an accommodating space 23a into which the post 223 is inserted is formed, and after the locking groove 23b extends in a horizontal direction so that the locking protrusion 223a of the post 223 is inserted in to the locking groove 23b, the locking groove 23b caught in a vertical direction, that is, a direction in which the crown 23 is separated from the post 223 is formed.

In addition, an elastomer 24 may be formed on the inner surface of the crown 23 (accommodating space 23a). Of course, the elastomer 24 may be formed on an outer surface of the post 223 instead of the crown 23. In this case, the elastomer 24 may be made of the same material as the elastomer 25 illustrated in the first embodiment of the present invention, and is installed between the crown 23 and the post 223 as in the first embodiment to buffer the crown 23 and the post 223.

In addition, the post 223 may be formed in a structure in which the upper end portion is separated from each other by a slit 223b so that the post 223 may be contracted when inserted into the accommodating space 23a while it is in close contact with the inner wall of the crown 23. In this case, the number and shape of the slits 223b are not limited. For example, the slit 223b may be formed in an oblique shape, a helical shape, or a whirlwind shape.

As illustrated in FIG. 7, the slit 223b extends from the upper portion to the upper end portion of the post 223 and may be formed in plurality. Accordingly, the upper portion of the post 223 is divided into a plurality of pieces in proportion to the number of slits 223b with the slit 223b as a boundary, including the locking protrusion 223a.

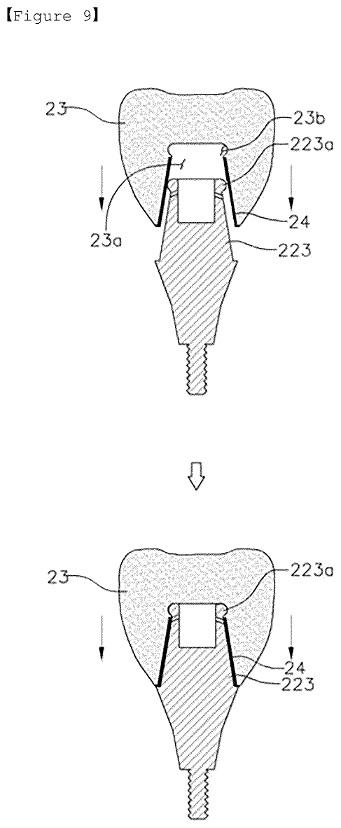

FIG. 9 is a cross-sectional view schematically illustrating a process of coupling the crown illustrated in FIG. 7 to the abutment.

As illustrated in FIG. 9, when the crown 23 is lowered, as the post 223 enters the accommodating space 23a, the inner wall of the crown 23 (the inner wall of the accommodating space 23a) presses the end portion of the locking protrusion 223a of the post 223 to press the locking protrusion 223a inward. As the locking protrusion 223a is divided into a plurality of pieces by the slit 223b, the locking protrusion 223a may be contracted by the inner wall of the crown 23, and when the locking protrusion 223a is inserted into and coupled to the locking groove 23b, the pressing force applied to the locking protrusion 223a is removed from the crown 23, so the locking protrusion 223a is restored to its original state by the elastic restoring force and extends. When the crown 23 is completely coupled to the post 223 so as to cover the outer surface of the post 223, the locking protrusion 223a is completely inserted into the locking groove 23b formed on the crown 23. Therefore, the crown 23 is not easily separated from the post 223 because it is mutually caught through the male-female coupling of the locking protrusion 223a and the locking groove 23b in the direction in which it is separated from the post 223.

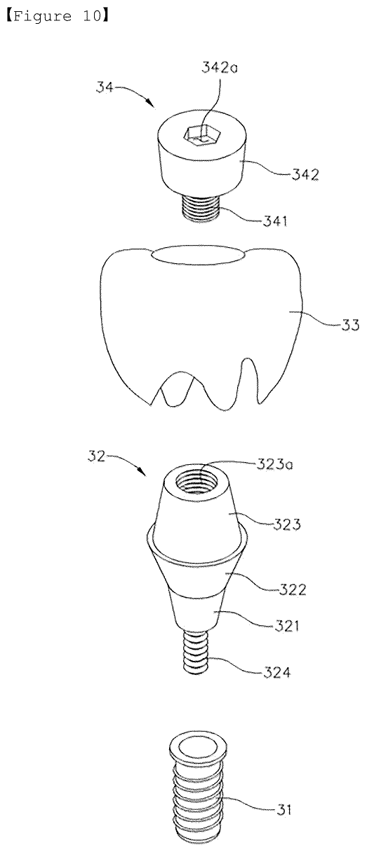

FIG. 10 is a diagram schematically illustrated to describe a dental implant structure according to a third embodiment of the present invention, and is a diagram separately illustrating each component of the implant structure.

Referring to FIG. 10, the dental implant structure according to the third embodiment of the present invention further includes a fixing member 34 for coupling and fixing the crown 34 to the abutment 32.

The abutment 32 includes a fixing part 321 coupled to the fixture 31 through a screw 324, a cuff 322 integrally formed on an upper portion of the fixing part 321, and post 323 formed on an upper portion of the cuff 322. The post 323 is formed in a center of the upper portion and includes a coupling groove part 323a to which the fixing member 34 for coupling and fixing the crown 33 to the abutment 32 is screwed.

The fixing member 34 is provided with a male screw part 341 screwed to the coupling groove part 323a of the post 323, and an upper portion of the male screw part 341 includes a head part 342 that is caught downward on an inner surface of the crown 33 and presses and fixes the crown 33 to the post 323.

The head part 342 is formed larger than the diameter of the upper end portion of the male screw part 341 so as to be caught on the inner surface of the crown 33. In addition, the head part 342 may be formed in a structure in which the diameter increases from the lower end toward the upper end portion. That is, in cross section, the side surface may be formed in an upwardly inclined structure. In addition, a driver groove 342a into which a driver tool is inserted may be formed at the upper portion of the head part 342 to rotate the fixing member 34 using the driver tool. In this case, the driver groove 342a may be formed in a straight, cross, or hexagonal structure.

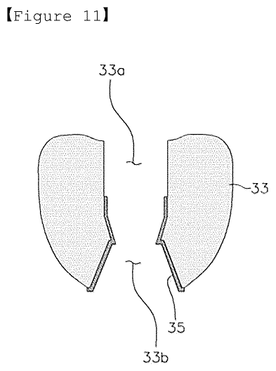

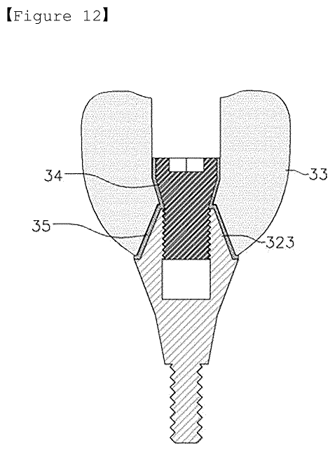

FIG. 11 is a cross-sectional view schematically illustrating the crown illustrated in FIG. 10, and FIG. 12 is a cross-sectional view illustrating a state in which the crown illustrated in FIG. 11 is coupled to the abutment through the fixing member.

As illustrated in FIGS. 10 to 12, the inside of the crown 33 is provided with a hollow 33a into which the fixing member 34 is inserted, an and accommodating space 33b which communicates vertically with the hollow 33a and in which the post 323 of the abutment 32 is inserted and accommodated. In this case, the inner structure of the accommodating space 33b is formed in a structure corresponding to a shape of an outer surface of the fixing member 34 so that a side surface of the head part 342 of the fixing member 34 is caught in a downward direction. Preferably, it may be formed in a structure in which an inner diameter of a central portion of the inner surface of the accommodating space 33b is narrow so that the side surface of the head part 342 of the fixing member 34 is caught in the downward direction (the direction coupled to the post 323).

In addition, an elastomer 35 may be attached to the inner surface of the accommodating space 33b of the crown 33 to buffer the gap between the crown 33 and the post 323 of the abutment 32. Of course, the elastomer 35 may be attached to the outer surface of the post 323 of the abutment 32 instead of the inner surface of the accommodating space 33b of the crown 33. In addition, the elastomer 35 may be manufactured independently and then installed between the posts 323 of the crown 33 and the abutment 32 that come into contact with each other.

Meanwhile, the fixing member 34 may be formed in a ‘T-shaped structure in cross section.

In the dental implant structures according to the embodiments of the present invention, the crown is not fixed to the abutment through the adhesive, but coupled and fixed to the abutment in the locking manner, and the elastomer is positioned between the crown and the abutment to relieve a pressure or shock transmitted to the abutment or a fixture, which is a lower structure, due to a repetitive occlusal force applied to the crown, and prevent foreign substances from entering the gap between the crown and the abutment.

Hereinabove, although preferred embodiments of the present invention have been described and illustrated using specific terms, such terms are only intended to clarify the present invention. It is obvious that various modifications and changes may be made to the embodiments of the present invention and the described terms without departing from the technical spirit and scope of the following claims. Such modified embodiments should not be individually understood from the spirit and scope of the present invention, and it is to be understood that the embodiments of the present invention fall within the scope of the claims of the present invention.

1. A dental implant structure, comprising:
an abutment;
a crown covering a post of the abutment and coupled and fixed to the post through a locking part; and
an elastomer positioned between the post and the crown,
wherein the elastomer is coated on an outer surface of the post except for a driver hole formed in the post.

2. The dental implant structure of claim 1, wherein the locking part is formed of an elastic ring inserted into an elastic ring insertion groove formed in a band shape on the outer surface of the post, and the elastic ring is caught in a locking groove formed on an inner surface of an accommodating space of the crown into which the post is inserted.

3. The dental implant structure of claim 1, wherein the locking part is formed of a locking protrusion whose diameter is expanded at an upper end portion of the post, and the locking protrusion is caught in a locking groove formed on an inner surface of the accommodating space of the crown into which the post is inserted.

4. The dental implant structure of claim 1, wherein the locking part is composed of a fixing member including a male screw part screwed to a coupling groove part formed in the post, and a head part formed at an upper end of the male screw part and caught in an inner surface of the accommodating space of the crown into which the post is inserted.

5. A dental implant structure, comprising:
an abutment;
a crown covering a post of the abutment and coupled and fixed to the post through a locking part; and
an elastomer positioned between the post and the crown,
wherein the elastomer is coated on an inner surface of the crown in which the post is accommodated.

6. The dental implant structure of claim 1, wherein the elastomer is made of any one selected from a silicone rubber material containing silicon, a synthetic rubber material containing fluorine, or a metal material made of a Ni—Ti alloy.

7. The dental implant structure of claim 1, wherein the elastomer is formed in a form of a fabric or membrane using a Ni—Ti alloy wire.

8. The dental implant structure of claim 7, wherein an empty space of the membrane formed through the Ni—Ti alloy wire is filled with a silicone rubber material containing silicon or a synthetic rubber material containing fluorine.

9. The dental implant structure of claim 1, wherein an antibiotic, an antibacterial agent, or a fragrance are added to the elastomer.

10. The dental implant structure of claim 2, wherein the elastic ring is formed in a form of an O-ring or a C-ring.

11. The dental implant structure of claim 5, wherein the elastomer is made of any one selected from a silicone rubber material containing silicon, a synthetic rubber material containing fluorine, or a metal material made of a Ni—Ti alloy.

12. The dental implant structure of claim 5, wherein the elastomer is formed in a form of a fabric or membrane using a Ni—Ti alloy wire.

13. The dental implant structure of claim 5, wherein an antibiotic, an antibacterial agent, or a fragrance are added to the elastomer.
